(19) United States
(12) Patent Application Publication
(10) Pub. No.: US 2021/0147298 A1
(43) Pub. Date: May 20, 2021

(54) CERAMIC RAW MATERIAL POWDER, DIELECTRIC GREEN SHEET, METHOD OF MAKING CERAMIC RAW MATERIAL POWDER, AND METHOD OF MANUFACTURING CERAMIC ELECTRONIC COMPONENT

(71) Applicant: TAIYO YUDEN CO., LTD., Tokyo (JP)

(72) Inventor: Katsuya TANIGUCHI, Tokyo (JP)

(73) Assignee: TAIYO YUDEN CO., LTD., Tokyo (JP)

(21) Appl. No.: 17/039,861

(22) Filed: Sep. 30, 2020

(30) Foreign Application Priority Data
Nov. 15, 2019 (JP) 2019-206844

(51) Int. Cl. C04B 35/468; H01G 4/30; H01G 4/12; C04B 35/63

(52) U.S. Cl. CPC C04B 35/4682; H01G 4/30; H01G 4/1227; C04B 2235/96; C04B 2235/42; C04B 2235/5454; C04B 2235/768; C04B 35/6303

(57) ABSTRACT

A ceramic raw material powder includes: ceramic particles having a perovskite structure containing barium, a mean particle diameter of the ceramic particles being 80 nm or greater and 150 nm or less; and chlorine, wherein a concentration of the chlorine to a B site element of the ceramic particles is 0.2 atm % or greater and 1.1 atm % or less.

### FIELD

A certain aspect of the present disclosure relates to ceramic raw material powder, a dielectric green sheet, a method of making ceramic raw material powder, and a method of manufacturing a ceramic electronic component.

### BACKGROUND

Ceramic electronic components such as multilayer ceramic capacitors have a structure designed to have dielectric layers and internal electrode layers alternately stacked. The dielectric layer can be formed by firing ceramic raw material powder as disclosed in, for example, Japanese Patent Application Publication Nos. 2009-190912 and 2016-94324.

### SUMMARY OF THE INVENTION

The ceramic electronic component is desired to have a smaller size and a larger capacitance. To meet these requests, the dielectric layer is required to be thinned. However, when the particle diameter of ceramic raw material powder is reduced to thin the dielectric layer, excessive growth of grains may occur. On the other hand, the reliability may degrade due to prevention of excessive growth of grains.

The present disclosure has a purpose of providing ceramic raw material powder, a dielectric green sheet, a method of making ceramic raw material powder, and a method of manufacturing a ceramic electronic component that are capable of inhibiting excessive growth of grains and reliability degradation.

According to a first aspect of the embodiments, there is provided a ceramic raw material powder including: ceramic raw material powder includes: ceramic particles having a perovskite structure containing barium, a mean particle diameter of the ceramic particles being 80 nm or greater and 150 nm or less; and chlorine, wherein a concentration of the chlorine to a B site element of the ceramic particles is 0.2 atm % or greater and 1.1 atm % or less.

According to a second aspect of the embodiments, there is provided a method of making a ceramic raw material powder, including: synthesizing ceramic particles having a perovskite structure containing barium; adjusting a mean particle diameter of the ceramic particles to be 80 nm or greater and 150 nm or less, wherein the synthesizing of the ceramic particles includes: synthesizing the ceramic particles from a barium compound raw material and a compound raw material of a B site element of the ceramic particles, and adjusting the concentration of chlorine to the B site element to be 0.2 atm % or greater and 1.1 atm % or less by causing at least one of the barium compound raw material and the compound raw material of the B site element to contain chlorine or by mixing the synthesized ceramic particles with a chlorine compound.

According to a third aspect of the embodiments, there is provided a dielectric green sheet including: ceramic particles having a perovskite structure containing barium, a mean particle diameter of the ceramic particles being 80 nm or greater and 150 nm or less; and chlorine, wherein a concentration of the chlorine to a B site element of the ceramic particles is 0.2 atm % or greater and 1.1 atm % or less.

According to a fourth aspect of the embodiments, there is provided a method of manufacturing a ceramic electronic component, including: forming a multilayer structure by alternately stacking a dielectric green sheet and a conductive paste for forming an internal electrode, the dielectric green sheet containing ceramic particles having a perovskite structure containing barium, and chlorine; and firing the multilayer structure, wherein in the dielectric green sheet, a mean particle diameter of the ceramic particles is 80 nm or greater and 150 nm or less, and a concentration of the chlorine to a B site element of the ceramic particles is 0.2 atm % or greater and 1.1 atm % or less.

### BRIEF DESCRIPTION OF THE DRAWINGS

FIG. 1 is a partial cross-sectional perspective view of a multilayer ceramic capacitor;

FIG. 2 is a flowchart illustrating a method of manufacturing the multilayer ceramic capacitor; and

FIG. 3A to FIG. 3D present the results of examples and comparative examples.

### DETAILED DESCRIPTION

Hereinafter, a description will be given of an embodiment with reference to the accompanying drawings.

### Embodiment

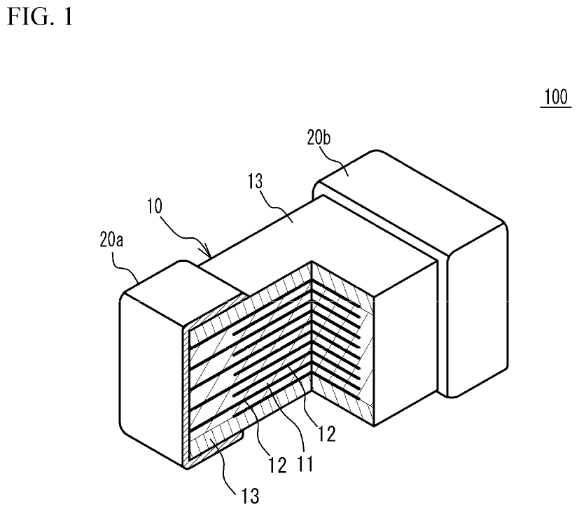

FIG. 1 is a partial cross-sectional perspective view of a multilayer ceramic capacitor 100 in accordance with an embodiment. As illustrated in FIG. 1, a multilayer ceramic capacitor 100 includes a multilayer chip 10 having a substantially rectangular parallelepiped shape, and external electrodes 20a and 20b that are provided on two edge faces of the multilayer chip 10 facing each other. Two faces other than the top face and the bottom face in the stack direction among four faces other than the two edge faces of the multilayer chip 10 are referred to as side faces. The external electrodes 20a and 20b extend to the top face, the bottom face, and two side faces. However, the external electrodes 20a and 20b are spaced from each other on the top face, the bottom face, and two side faces.

The multilayer chip 10 has a structure designed to have dielectric layers 11 and internal electrode layers 12 alternately stacked. The dielectric layer 11 contains a ceramic material acting as a dielectric material. The internal electrode layer 12 contains a base metal material. End edges of the internal electrode layers 12 are alternately exposed to a first edge face of the multilayer chip 10 and a second edge face of the multilayer chip 10 that is different from the first edge face. The external electrode 20a is provided on the first edge face. The external electrode 20b is provided on the second edge face. Thus, the internal electrode layers 12 are alternately electrically connected to the external electrode 20a and the external electrode 20b. Thus, the multilayer ceramic capacitor 100 has a structure in which a plurality of the dielectric layers 11 is stacked with the internal electrode layer 12 interposed between each two of the dielectric layers 11. In the multilayer structure formed of the dielectric layers 11 and the internal electrode layers 12, the outermost layers in the stack direction are the internal electrode layers 12, and the top face and the bottom face of the multilayer body are covered by cover layers 13. A main component of the cover layer 13 is a ceramic material. For example, the main component of the cover layer 13 is the same as the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layers 12 is a base metal such as nickel (Ni), copper (Cu), tin (Sn) or the like. The internal electrode layers 12 may be made of noble metal such as platinum (Pt), palladium (Pd), silver (Ag), gold (Au) or alloy thereof.

The dielectric layer 11 is mainly composed of a ceramic material having a perovskite structure expressed by a general formula ABO₃. The perovskite structure includes ABO_{3-α} having an off-stoichiometric composition. In the present embodiment, a ceramic material having a perovskite structure in which barium (Ba) is positioned at the A site is employed. Examples of such a ceramic material include, but are not limited to, barium titanate (BaTiO₃) and Ba_{1-x-y}CaₓSr_{y}Ti_{1-z}Zr_{z}O₃ (0≤x≤1, 0≤y≤1, 0≤z≤1) having a perovskite structure.

The dielectric layer 11 is obtained by, for example, firing ceramic raw material powder. In the present embodiment, barium titanate powder is employed as an example of the ceramic raw material powder. Barium titanate particles contained in the ceramic raw material powder is synthesized by mixing particulate barium compound raw material and particulate titanium compound raw material with use of, for example, solid phase synthesis, and then drying and firing the resulting material. The barium compound raw material is, for example, barium carbonate (BaCO₃). The titanium compound raw material is, for example, titanium dioxide (TiO₂).

In the production process for producing the titanium compound raw material such as titanium dioxide, chlorine (Cl) becomes contained in the titanium compound raw material. Also in the production process for producing the barium compound raw material such as barium carbonate, chlorine may become contained in the barium compound raw material. The amount of chlorine to be contained varies depending on the condition of the production process. This chlorine becomes contained also in the ceramic raw material powder. Depending on the amount of chlorine, physical properties of barium titanate, the sintered behavior of the multilayer ceramic capacitor 100, and electrical characteristics vary.

To make the multilayer ceramic capacitor 100 have a smaller size and a larger capacitance, the dielectric layer 11 is desired to be thinned. To thin the dielectric layer 11, it is desired to use ceramic raw material powder with a small particle size. However, the ceramic raw material powder with a small particle size has a large specific surface area, therefore having high reactivity. Thus, grain growth is likely to occur during firing. On the other hand, inhibition of grain growth may degrade the reliability such as the lifetime characteristic. The inventor has found that excessive growth of grains is inhibited and degradation in the reliability such as the lifetime characteristic is inhibited by adjusting the contained amount of chlorine when the ceramic raw material powder with a small particle size is used.

When the ceramic raw material powder contains chlorine, barium chloride (BaCl₂) or the like forms a liquid phase at a relatively low temperature (for example, approximately 950° C.) during firing of the ceramic raw material powder. This increases sinterability of barium titanate. In addition, barium chloride or the like wets and spreads on the surface of barium titanate, effectively inhibiting dissolution of barium in the barium titanate particles. Thus, excessive growth of grains is inhibited. However, when the amount of chlorine is too small, the sufficient effect may be unlikely to be achieved. Thus, in this embodiment, a lower limit is set for the contained amount of chlorine. Specifically, the contained amount of chlorine in the ceramic raw material powder is made to be 0.2 atm % or greater. The contained amount of chlorine here is atm % of chlorine atoms when atm % of titanium (Ti) in the barium titanate particles is defined as 100 atm %. When the material other than barium titanate is used, the contained amount of chlorine is atm % of chlorine atoms when atm % of the B site element is defined as 100 atm %. Chlorine may be contained inside the barium titanate particles, or may be contained outside the barium titanate particles in the form of a chlorine compound. The chlorine compound is ammonium chloride (NH₄Cl), barium chloride (BaCl₂), or the like.

On the other hand, when the contained amount of chlorine is too large, residual chlorine may react with nickel of the internal electrode to produce nickel chloride (NiCl₂). This may degrade the reliability such as the lifetime characteristic of the multilayer ceramic capacitor 100. Thus, in the present embodiment, an upper limit is set for the contained amount of chlorine. Specifically, the contained amount of chlorine in the ceramic raw material powder is made to be 1.1 atm % or less.

In addition, when the mean particle diameter of the barium titanate particles is too small, grain growth of barium titanate may be unlikely to be sufficiently inhibited. Thus, in the present embodiment, a lower limit is set for the mean particle diameter. Specifically, the mean particle diameter of the barium titanate particles contained in the ceramic raw material powder is made to be 80 nm or greater.

On the other hand, when the mean particle diameter of the barium titanate particles is too large, the flatness of the green sheet for forming the dielectric layer 11 decreases, and thereby, the reliability may degrade. Thus, in the present embodiment, an upper limit is set for the mean particle diameter. Specifically, the mean particle diameter of the barium titanate particles is made to be 150 nm or less.

As described above, the present embodiment uses the ceramic raw material powder containing barium titanate particles having a mean particle diameter of 80 nm or greater and 150 nm or less, and of which the contained amount of chlorine is 0.2 atm % or greater and 1.1 atm % or less. This inhibits excessive growth of grains and reliability degradation.

To inhibit the grain growth of barium titanate, the contained amount of chlorine in the ceramic raw material powder is preferably 0.2 atm % or greater, more preferably 0.4 atm % or greater. To inhibit reliability degradation, the contained amount of chlorine in the ceramic raw material powder is preferably 1.1 atm % or less, more preferably 0.9 atm % or less. In addition, to inhibit the grain growth of barium titanate, the mean particle diameter of the barium titanate particles is preferably 50 nm or greater, more preferably 80 nm or greater. To inhibit reliability degradation, the mean particle diameter of the barium titanate particles is preferably 180 nm or less, more preferably 150 nm or less.

The mean particle diameter of the barium titanate particles can be measured as follows. First, the powder to be measured is observed by an electron scanning microscope at, for example, 50,000-fold to 100,000-fold observation magnification, and the length of the longest line (the long-axis length) among the lines crossing the particle to be measured and the length of the shortest line (the short-axis length) among the lines crossing the particle to be measured are measured. The value calculated by (the long-axis length+the short-axis length)/2 is defined as the particle diameter of the particle to be measured. The particle diameters of 100 particles are measured, and the average value of them is used as the mean particle diameter.

The contained amount of chlorine in the ceramic raw material powder can be measured by analyzing a solution obtained by dissolving the ceramic raw material powder in acid fluid with an inductively coupled plasma (ICP) emission spectrophotometer.

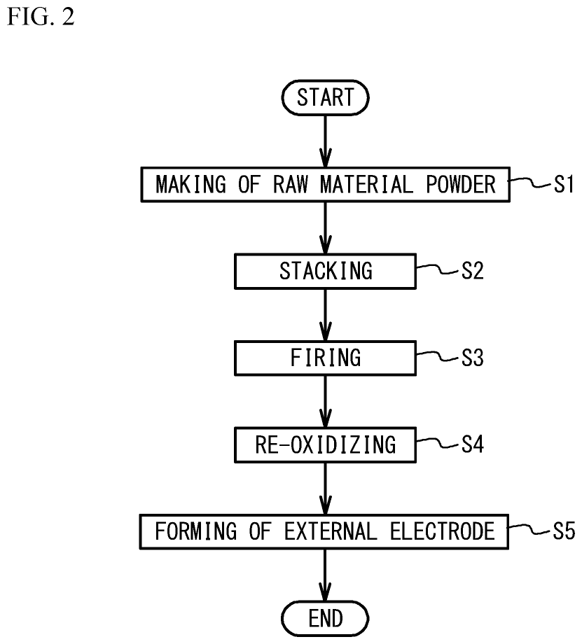

Next, a description will be given of a method of manufacturing the multilayer ceramic capacitor 100. FIG. 2 is a flowchart illustrating a method of manufacturing the multilayer ceramic capacitor 100.

### [Making Process of Raw Material Powder (S1)]

A dielectric material for forming the dielectric layer 11 is prepared. The A site element and the B site element contained in the dielectric layer 11 are contained in the dielectric layer 11 typically in the form of a sintered compact of ABO₃ particles. For example, barium titanate is a tetragonal compound having a perovskite structure, and exhibits high permittivity.

Barium titanate powder is synthesized from a particulate barium compound raw material such as barium carbonate and a particulate titanium compound raw material such as titanium dioxide. For example, the solid phase method, the sol-gel method, the hydrothermal method, and the like are known as the synthesizing method. In the present embodiment, any one of them can be employed. Chlorine is contained in at least one of the barium compound raw material and the titanium compound raw material. The synthesis condition is adjusted such that the contained amount of chlorine is 0.2 atm % or greater and 1.1 atm % or less in the barium titanate particles after synthesis.

When ceramic particles other than barium titanate are synthesized, the ceramic particles can be synthesized from the barium compound raw material and a compound raw material of the B site element. In this case, chlorine is contained in at least one of the barium compound raw material and the compound raw material of the B site element.

Additive compound may be added to the resulting barium titanate powder in accordance with purposes. The additive compound may be an oxide of magnesium (Mg), manganese (Mn), vanadium (V), chromium (Cr) or a rare earth element (yttrium (Y), dysprosium (Dy), thulium (Tm), holmium (Ho), terbium (Tb), ytterbium (Yb), samarium (Sm), europium (Eu), gadolinium (Gd), and erbium (Er)), or an oxide of cobalt (Co), Ni, lithium (Li), B, sodium (Na), potassium (K) and Si, or glass.

For example, the barium titanate powder is wet-blended with a compound including additive compound, is dried and is crushed. The resulting material may be crushed as needed to adjust the particle size, or the particle size of the resulting material may be adjusted in combination with a classification treatment. In this embodiment, the particle size is adjusted such that the mean particle diameter of the barium titanate particles is 80 nm or greater and 150 nm or less. Through the above process, the ceramic raw material powder to be the main component of the dielectric layer is obtained.

The contained amount of chlorine may be adjusted to be 0.2 atm % or greater and 1.1 atm % or less by mixing the ceramic raw material powder with a chlorine compound such as ammonium chloride, barium chloride, or the like.

### [Stacking Process (S2)]

Next, a binder such as polyvinyl butyral (PVB) resin, an organic solvent such as ethanol or toluene, and a plasticizer are added to the resulting ceramic raw material powder and wet-blended. With use of the resulting slurry, a dielectric green sheet is coated on a base material by, for example, a die coater method or a doctor blade method, and then dried. When the contained amount of chlorine is insufficient, the contained amount of chlorine may be adjusted to be 0.2 atm % or greater and 1.1 atm % or less by mixing the slurry with a chlorine compound such as ammonium chloride, barium chloride, or the like.

Then, a pattern of an internal electrode layer is formed on the surface of a dielectric green sheet by printing a conductive paste for forming the internal electrode with use of screen printing or gravure printing. The conductive paste for forming the internal electrode contains an organic binder. The internal electrode layer patterns are to be alternately led out to a pair of external electrodes of different polarizations. Ceramic particles are added as a co-material to the metal conductive paste. The main component of the ceramic particles is not particularly limited, but is preferably the same as the ceramic that is the main component of the dielectric layer 11. For example, barium titanate with a mean particle diameter of 50 nm or less may be evenly dispersed.

Thereafter, the dielectric green sheets each on which the internal electrode layer pattern is printed are stamped into a predetermined size. Then, a predetermined number (for example, 100 to 500) of stamped dielectric green sheets are stacked while the base material is peeled so that the internal electrode layers 12 and the dielectric layers 11 are alternated with each other and the end edges of the internal electrode layers 12 are alternately exposed to both edge faces in the length direction of the dielectric layer 11 so as to be alternately led out to a pair of external electrodes of different polarizations. Cover sheets, which are to be the cover layers 13, are compressed on the stacked green sheets and under the stacked sheets. The resulting compact is cut into a predetermined size (for example, 1.0 mm×0.5 mm). Thereafter, a metal conductive paste, which is to be a base layer for the external electrodes 20a and 20b, is applied to both edge faces of the multilayer structure by dipping or the like and is then dried. Through this, a molded body for forming the multilayer ceramic capacitor 100 is obtained.

### [Firing Process (S3)]

The binder is removed from the molded body made in the stacking process in N₂ atmosphere in a temperature range of 250° C. to 500° C. After that, the resulting molded body is fired for 10 minutes to 2 hours in a reductive atmosphere with an oxygen partial pressure of 10⁻⁵ atm to 10⁻⁸ atm in a temperature range of 1100° C. to 1300° C.

### [Re-oxidizing Process (S4)]

Thereafter, the re-oxidizing process is performed in a N₂ gas atmosphere in a temperature range of 600° C. to 1000° C. This process reduces the oxygen defect concentration.

### [Forming Process of External Electrodes (S5)]

Thereafter, a metal such as Cu, Ni, or Sn is coated on the base layers of the external electrodes 20a and 20b by plating. Through the above processes, the multilayer ceramic capacitor 100 is completed.

In the manufacturing method in accordance with the present embodiment, used is the ceramic raw material powder containing barium titanate particles with a mean particle diameter of 80 nm or greater and 150 nm or less and of which the contained amount of chlorine is 0.2 atm % or greater and 1.1 atm % or less. Alternatively, used is a dielectric green sheet containing barium titanate particles with a mean particle diameter of 80 nm or greater and 150 nm or less and of which the contained amount of chlorine is 0.2 atm % or greater and 1.1 atm % or less. Thus, excessive growth of grains is inhibited and reliability degradation is inhibited.

In the above example, the multilayer ceramic capacitor is described as an example of the ceramic electronic component, but this does not intend to suggest any limitation. For example, other electronic components such as a varistor and a thermistor may be used.

### EXAMPLES

### Examples 1 to 9 and Comparative Examples 1 to 26

Barium titanate particles containing impurity chlorine were synthesized by solid phase synthesizing a titanium oxide raw material containing chlorine and a barium carbonate raw material containing chlorine. In an example 1, the mean particle diameter of the barium titanate particles was 80 nm, and the contained amount of chlorine was 0.2 atm %. In an example 2, the mean particle diameter of the barium titanate particles was 80 nm, and the contained amount of chlorine was 0.5 atm %. In an example 3, the mean particle diameter of the barium titanate particles was 80 nm, and the contained amount of chlorine was 1.1 atm %. In an example 4, the mean particle diameter of the barium titanate particles was 100 nm, and the contained amount of chlorine was 0.2 atm %. In an example 5, the mean particle diameter of the barium titanate particles was 100 nm, and the contained amount of chlorine was 0.5 atm %. In an example 6, the mean particle diameter of the barium titanate particles was 100 nm, and the contained amount of chlorine was 1.1 atm %. In an example 7, the mean particle diameter of the barium titanate particles was 150 nm, and the contained amount of chlorine was 0.2 atm %. In an example 8, the mean particle diameter of the barium titanate particles was 150 nm, and the contained amount of chlorine was 0.5 atm %. In an example 9, the mean particle diameter of the barium titanate particles was 150 nm, and the contained amount of chlorine was 1.1 atm %.

In a comparative example 1, the mean particle diameter of the barium titanate particles was 50 nm, and the contained amount of chlorine was 0 atm %. In a comparative example 2, the mean particle diameter of the barium titanate particles was 50 nm, and the contained amount of chlorine was 0.1 atm %. In a comparative example 3, the mean particle diameter of the barium titanate particles was 50 nm, and the contained amount of chlorine was 0.2 atm %. In a comparative example 4, the mean particle diameter of the barium titanate particles was 50 nm, and the contained amount of chlorine was 0.5 atm %. In a comparative example 5, the mean particle diameter of the barium titanate particles was 50 nm, and the contained amount of chlorine was 1.1 atm %. In a comparative example 6, the mean particle diameter of the barium titanate particles was 50 nm, and the contained amount of chlorine was 1.2 atm %. In a comparative example 7, the mean particle diameter of the barium titanate particles was 50 nm, and the contained amount of chlorine was 1.5 atm %.

In a comparative example 8, the mean particle diameter of the barium titanate particles was 80 nm, and the contained amount of chlorine was 0 atm %. In a comparative example 9, the mean particle diameter of the barium titanate particles was 80 nm, and the contained amount of chlorine was 0.1 atm %. In a comparative example 10, the mean particle diameter of the barium titanate particles was 80 nm, and the contained amount of chlorine was 1.2 atm %. In a comparative example 11, the mean particle diameter of the barium titanate particles was 80 nm, and the contained amount of chlorine was 1.5 atm %.

In a comparative example 12, the mean particle diameter of the barium titanate particles was 100 nm, and the contained amount of chlorine was 0 atm %. In a comparative example 13, the mean particle diameter of the barium titanate particles was 100 nm, and the contained amount of chlorine was 0.1 atm %. In a comparative example 14, the mean particle diameter of the barium titanate particles was 100 nm, and the contained amount of chlorine was 1.2 atm %. In a comparative example 15, the mean particle diameter of the barium titanate particles was 100 nm, and the contained amount of chlorine was 1.5 atm %.

In a comparative example 16, the mean particle diameter of the barium titanate particles was 150 nm, and the contained amount of chlorine was 0 atm %. In a comparative example 17, the mean particle diameter of the barium titanate particles was 150 nm, and the contained amount of chlorine was 0.1 atm %. In a comparative example 18, the mean particle diameter of the barium titanate particles was 150 nm, and the contained amount of chlorine was 1.2 atm %. In a comparative example 19, the mean particle diameter of the barium titanate particles was 150 nm, and the contained amount of chlorine was 1.5 atm %.

In a comparative example 20, the mean particle diameter of the barium titanate particles was 180 nm, and the contained amount of chlorine was 0 atm %. In a comparative example 21, the mean particle diameter of the barium titanate particles was 180 nm, and the contained amount of chlorine was 0.1 atm %. In a comparative example 22, the mean particle diameter of the barium titanate particles was 180 nm, and the contained amount of chlorine was 0.2 atm %. In a comparative example 23, the mean particle diameter of the barium titanate particles was 180 nm, and the contained amount of chlorine was 0.5 atm %. In a comparative example 24, the mean particle diameter of the barium titanate particles was 180 nm, and the contained amount of chlorine was 1.1 atm %. In a comparative example 25, the mean particle diameter of the barium titanate particles was 180 nm, and the contained amount of chlorine was 1.2 atm %. In a comparative example 26, the mean particle diameter of the barium titanate particles was 180 nm, and the contained amount of chlorine was 1.5 atm %.

Additives (rare-earth oxide, magnesium oxide (MgO), magnesium carbonate (MnCO₃), silicon dioxide (SiO₂), barium carbonate (BaCO₃), and the like), organic solvent (ethanol or the like), and PVB resin as a binder were added to the barium titanate particles to obtain slurry. The resulting slurry was shaped into a sheet by a doctor blade method or the like to obtain a dielectric green sheet.

A metal conductive paste for forming the internal electrode layer was printed on the resulting dielectric green sheet. Three hundreds of the dielectric green sheets each on which a metal conductive paste was printed were stacked. Coversheets were stacked on the top and the bottom of the multilayer structure of the dielectric green sheets and heated and compressed. Thereafter, the resulting multilayer structure was cut into a predetermined shape, and the binder is removed from the multilayer structure in N₂ atmosphere. Ni external electrodes were formed on the resulting multilayer structure by dipping, and the multilayer structure was fired under a reductive atmosphere (O₂ partial pressure: 10⁻⁵ atm to 10⁻⁸ atm) at 1250° C. to obtain a sintered compact. The shape size was a length of 1.0 mm, a width of 0.5 mm, and a height of 0.5 mm. The sintered compact was re-oxidized under N₂ atmosphere in the condition of 800° C., and a metal of Cu, Ni, Sn was coated on the surfaces of the external electrode terminals by plating to obtain the multilayer ceramic capacitor 100. After firing, the thickness of the dielectric layer 11 was 1.0 μm. The thickness of the internal electrode layer 12 was 0.8 μm.

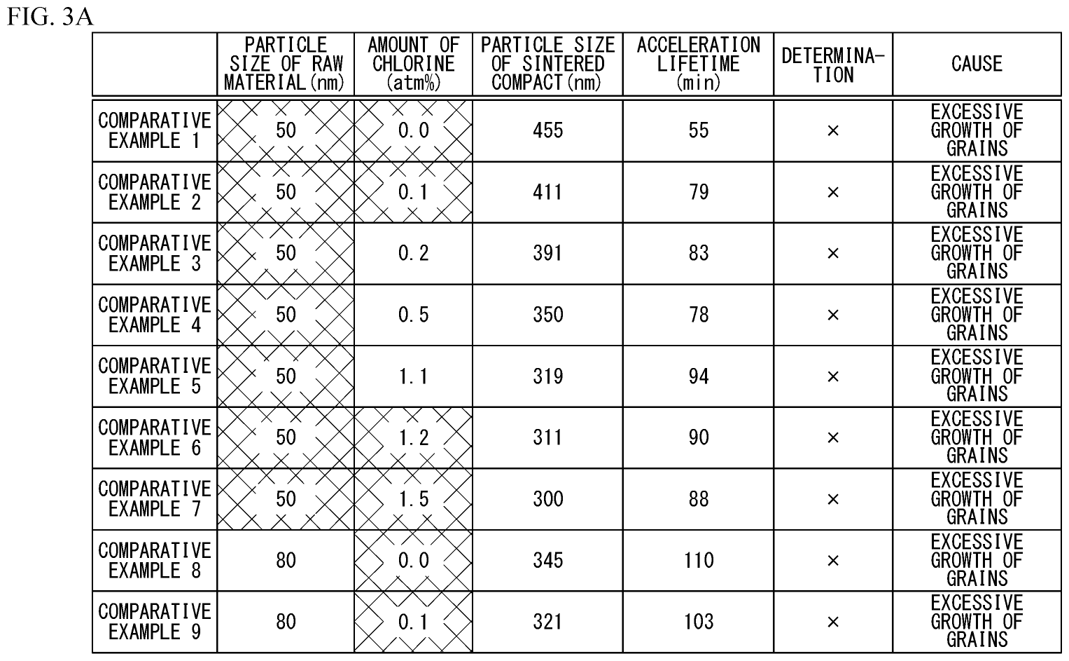

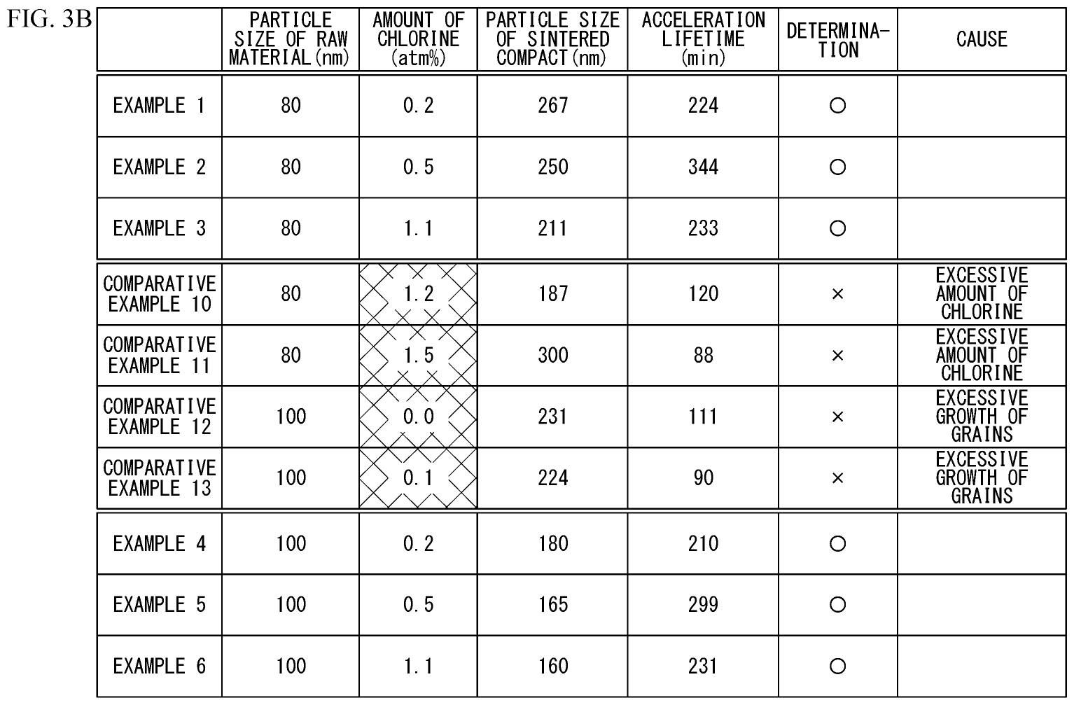

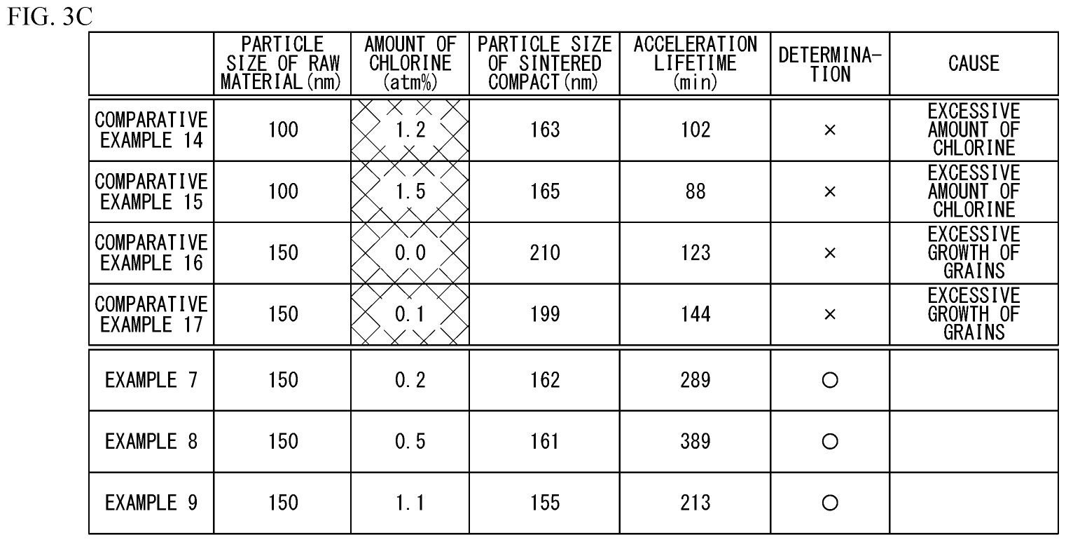

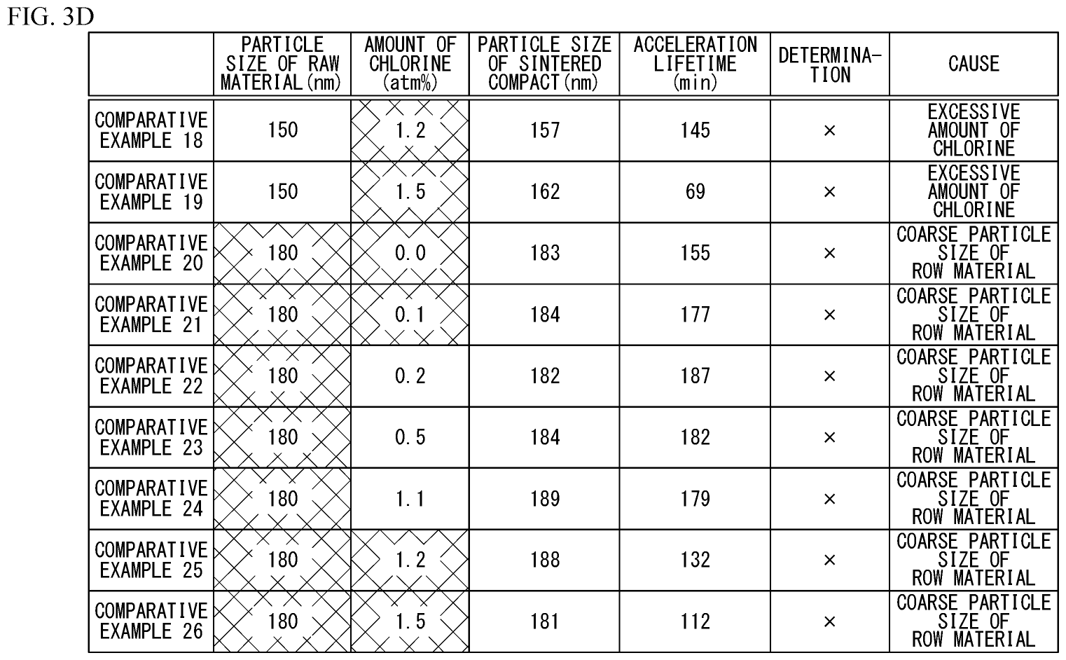

For 100 samples of each of the examples 1 to 9 and the comparative examples 1 to 26, the mean diameter (nm) of sintered particles in the obtained dielectric layer 11 and the acceleration lifetime value (the median value (min) of the time to the occurrence of short circuit at a temperature of 125 □ when 10 V was applied) are presented in FIG. 3A to FIG. 3D. It was determined that excessive growth of grains occurred when the mean diameter of the sintered particles was 300 nm or greater. In addition, it was determined that the reliability degraded when the acceleration lifetime value was less than 200 min. It was determined that the sample was rejectable “x” when at least one of excessive growth of grains and reliability degradation occurred. It was determined that the sample was acceptable “◯” when neither excessive growth of grains nor reliability degradation occurred.

All the comparative examples 1 to 26 were determined to be rejectable “X”. This is considered because the barium titanate powder used in the comparative examples 1 to 26 did not satisfy the condition that the mean diameter of the barium titanate particles was 80 nm or greater and 150 nm or less, or did not satisfy the condition that the contained amount of chlorine was 0.2 atm % or greater and 1.1 atm % or less. On the other hand, all the examples 1 to 9 were determined to be acceptable “◯”. This is considered because the barium titanate powder contains the barium titanate particles with a mean particle diameter of 80 nm or greater and 150 nm or less and of which the contained amount of chlorine was 0.2 atm % or greater and 1.1 atm % or less was used.

Although the embodiments of the present invention have been described in detail, it is to be understood that the various change, substitutions, and alterations could be made hereto without departing from the spirit and scope of the invention.

What is claimed is:

1. A ceramic raw material powder comprising:
ceramic particles having a perovskite structure containing barium, a mean particle diameter of the ceramic particles being 80 nm or greater and 150 nm or less; and
chlorine,
wherein a concentration of the chlorine to a B site element of the ceramic particles is 0.2 atm % or greater and 1.1 atm % or less.

2. The ceramic raw material powder according to claim 1, wherein the ceramic particles are barium titanate particles.

3. The ceramic raw material powder according to claim 1, wherein at least some of the chlorine contained therein is in a form of a chlorine compound.

4. A method of making a ceramic raw material powder, comprising:
synthesizing ceramic particles having a perovskite structure containing barium;
adjusting a mean particle diameter of the ceramic particles to be 80 nm or greater and 150 nm or less,
wherein the synthesizing of the ceramic particles includes:
synthesizing the ceramic particles from a barium compound raw material and a compound raw material of a B site element of the ceramic particles, and
adjusting the concentration of chlorine to the B site element to be 0.2 atm % or greater and 1.1 atm % or less by causing at least one of the barium compound raw material and the compound raw material of the B site element to contain chlorine or by mixing the synthesized ceramic particles with a chlorine compound.

5. The method according to claim 4, wherein the ceramic particles are barium titanate particles.

6. A dielectric green sheet comprising:
ceramic particles having a perovskite structure containing barium, a mean particle diameter of the ceramic particles being 80 nm or greater and 150 nm or less; and
chlorine,
wherein a concentration of the chlorine to a B site element of the ceramic particles is 0.2 atm % or greater and 1.1 atm % or less.

7. The dielectric green sheet according to claim 6, wherein the ceramic particles are barium titanate particles.

8. The dielectric green sheet according to claim 6, wherein at least some of the chlorine contained therein is in a form of a chlorine compound.

9. A method of manufacturing a ceramic electronic component, comprising:
forming a multilayer structure by alternately stacking a dielectric green sheet and a conductive paste for forming an internal electrode, the dielectric green sheet containing ceramic particles having a perovskite structure containing barium, and chlorine; and
firing the multilayer structure,
wherein in the dielectric green sheet, a mean particle diameter of the ceramic particles is 80 nm or greater and 150 nm or less, and a concentration of the chlorine to a B site element of the ceramic particles is 0.2 atm % or greater and 1.1 atm % or less.

10. The method according to claim 9, wherein the dielectric green sheet contains a chlorine compound.

11. The method according to claim 9, wherein the ceramic particles are barium titanate particles.

12. The method according to claim 9, wherein the ceramic electronic component is a multilayer ceramic capacitor.
